(19) United States
(12) Patent Application Publication
(10) Pub. No.: US 2015/0194157 A1
(43) Pub. Date: Jul. 9, 2015

(54) SYSTEM, METHOD, AND COMPUTER PROGRAM PRODUCT FOR ARTIFACT REDUCTION IN HIGH-FREQUENCY REGENERATION AUDIO SIGNALS

(71) Applicant: NVIDIA Corporation, Santa Clara, CA (US)

(72) Inventor: Anil Wamanrao Ubale, Cupertino, CA (US)

(73) Assignee: NVIDIA Corporation, Santa Clara, CA (US)

(21) Appl. No.: 14/148,521

(22) Filed: Jan. 6, 2014

(51) Int. Cl. G10L 19/005; G10L 19/26

(52) U.S. Cl. CPC G10L 19/005; G10L 19/265

(57) ABSTRACT

A system, method, and computer program product are provided for artifact reduction in high-frequency regeneration audio signals. In operation, a high-frequency regeneration (HFR) audio signal is received. Additionally, one or more artifacts are detected in the received HFR audio signal, utilizing a spectral energy associated with the received HFR audio signal. Further, the received HFR audio signal is modified to at least partially correct the one or more artifacts in the received HFR audio signal.

### FIELD OF THE INVENTION

The present invention relates to signal error correction, and more particularly to correcting artifacts in high-frequency regeneration audio signals.

### BACKGROUND

Many new low-bit rate audio compression technologies are based on the concept of high-frequency regeneration (HFR). For example, High-Efficiency Advanced Audio Coding (HE-AAC), Dolby Digital Plus (E-AC3), MP3Pro, WMAPro Low Bit Rate versions all use high-frequency regeneration. Both HE-AAC v2 and E-AC3 are used for digital TV transmission. HE-AACv2 is the part of ISDB-T terrestrial TV transmission standard and E-AC3 is adopted as the audio compression specification for ATSC digital TV transmission standard.

The advantage of these technologies is the bit-rate efficiency. In these codecs, typically only the lower frequencies of the audio signal are encoded using a core encoding format. The high-frequencies of the audio signal are regenerated at the receiver. The transmitter only sends very low bit-rate side information to help the receiver in regenerating the high-frequencies.

In the HE-AAC specification, the high-frequency regeneration is accomplished using a technique called spectral band replication (SBR). In E-AC3, this technique is referred to as Spectral Extension Processing. The core decoder in case of HE-AAC is MPEG2 Advanced Audio Coding (MPEG2-AAC), while in case of E-AC3 it is AC3.

Unfortunately, in the case of codecs that utilize high-frequency generation techniques, an error in the side information data that is used by the receiver for high-frequency generation can cause severe artifacts. Thus, there is a need for addressing this issue and/or other issues associated with the prior art.

### SUMMARY

A system, method, and computer program product are provided for artifact reduction in high-frequency regeneration audio signals. In operation, a high-frequency regeneration (HFR) audio signal is received. Additionally, one or more artifacts are detected in the received HFR audio signal, utilizing a spectral energy associated with the received HFR audio signal. Further, the received HFR audio signal is modified to at least partially correct the one or more artifacts in the received HFR audio signal.

### BRIEF DESCRIPTION OF THE DRAWINGS

FIG. 1 illustrates a flowchart of a method for artifact reduction in high-frequency regeneration (HFR) audio signals, in accordance with one embodiment.

FIG. 2 illustrates a decoder system for artifact reduction in high-frequency regeneration audio signals, in accordance with one embodiment.

FIG. 3 illustrates a flowchart of a method for artifact reduction in high-frequency regeneration audio signals, in accordance with another embodiment.

FIG. 4 shows an example of an enhanced AAC+ data frame, in accordance with one embodiment.

FIG. 5 shows a frame of data that follows the frame of data shown in FIG. 4, in accordance with one embodiment.

FIG. 6 shows a frame of data that follows the frame of data shown in FIG. 5, in accordance with one embodiment.

FIG. 7 shows a frame of data that follows the frame of data shown in FIG. 6, in accordance with one embodiment.

FIG. 8 illustrates an exemplary system in which the various architecture and/or functionality of the various previous embodiments may be implemented.

### DETAILED DESCRIPTION

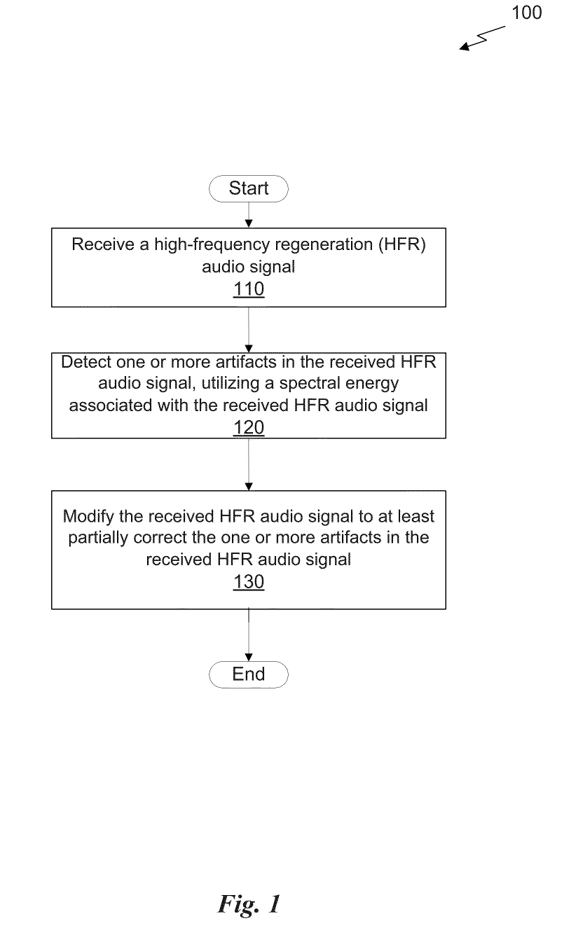

FIG. 1 illustrates a flowchart of a method 100 for artifact reduction in high-frequency regeneration (HFR) audio signals, in accordance with one embodiment. In operation, a high-frequency regeneration audio signal is received. See operation 110. Additionally, one or more artifacts are detected in the received HFR audio signal, utilizing a spectral energy associated with the received HFR audio signal. See operation 120. Further, the received HFR audio signal is modified to at least partially correct the one or more artifacts in the received HFR audio signal. See operation 130. The artifacts may include any detectable artifact in an HFR audio signal. For example, the artifacts may include artifacts caused in HFR codecs (e.g. squeaks, etc.).

In various embodiments, different techniques may be utilized to detect artifacts in the HFR audio signal. For example, in one embodiment, detecting the one or more artifacts in the received HFR audio signal may include detecting a change in the spectral energy of the HFR audio signal. In this case, the detected change in the in the spectral energy of the HFR audio signal may be compared to a determined threshold in order to detect the one or more artifacts in the received HFR audio signal. In the context of the present description, spectral energy refers to the energy associated with a signal for a particular frequency (or wavelength).

In another embodiment, detecting the one or more artifacts in the received HFR audio signal may include detecting an increase in the spectral energy for a regenerated high-frequency band associated with the received HFR audio signal with respect to the spectral energy for a lower-frequency band associated with the received HFR audio signal, and a frame to frame spectral energy associated with the HFR audio signal. For example, the change in spectral energy of the high-frequency band may be large compared to a change of the spectral energy in the lower-frequency band (e.g. the change may be outside of a threshold, etc.).

If there is a change in the spectral energy of the high-frequency band and a change the spectral energy for a lower-frequency band that is indicative of the presence of an artifact, but such change is observed over two or more frames, in one embodiment, it may be determined that such change is indicative of real data and the signal may not be modified (or may not be modified after the detection in two or more subsequent frames, etc.). It should be noted that that changes in the spectral energy for a lower-frequency band and changes in the spectral energy for a high-frequency band may be in the same direction (e.g. but different magnitudes, etc.) or in opposing directions.

In either case, in one embodiment, the difference in the change in the spectral energy for the lower-frequency band and the high-frequency band may be compared to a threshold to determine if the change is indicative of an undesired artifact in the data. Additionally, a determination of whether to modify the spectral energy of the high-frequency band to correct any undesired artifacts may be made based on the comparison. In one embodiment, the spectral energy of the high-frequency band may be modified, based on the comparison.

In some cases, the change the spectral energy of the high-frequency band may be large compared to the change in the spectral energy of the frame to frame HFR audio signal. In these cases, in one embodiment, the respective changes may be compared to a threshold to determine whether the magnitude of the change is indicative of the presence of one or more undesired artifacts in the HFR audio signal.

Still yet, in one embodiment, modifying the received HFR audio signal to correct the artifacts in the received HFR audio signal may include computing a defined normal (i.e. a norm) of a lower-band magnitude spectrum obtained at an output of an analysis filter-bank. Additionally, a norm of an upper-band magnitude spectrum obtained at an output of an HFR module may be computed. Further, a scaling factor for the upper-band magnitude spectrum may be determined, based on the norm of a lower-band magnitude spectrum and the norm of the upper-band magnitude spectrum.

Subsequently, in one embodiment, the upper-band magnitude spectrum may be attenuated, based on the determined scaling factor (e.g. to reduce an energy associated with upper-band spectrum coefficients, etc.), and a frequency-to-time conversion may be performed on a signal associated with the attenuated upper-band magnitude spectrum. In this case, the modified received HFR audio signal may include a result of performing the frequency-to-time conversion on the signal associated with the attenuated upper-band magnitude spectrum.

In the context of the present description, the defined normal (i.e. the norm) refers to a value and/or magnitude associated with the spectral energy for particular frequency or band of frequencies corresponding to a frame of data. The norm of the lower-band magnitude spectrum and the norm of the upper-band magnitude spectrum may be determined utilizing a variety of techniques, including utilizing an operation for determining a maximum (e.g. a max operation, etc.), an operation for determining the square root of the maximum (e.g. a square-max operation), or an operation for determining an average. As one example, the defined normal may include a maximum magnitude across time-slots and frequency bins for a frame of data.

More illustrative information will now be set forth regarding various optional architectures and features with which the foregoing framework may or may not be implemented, per the desires of the user. It should be strongly noted that the following information is set forth for illustrative purposes and should not be construed as limiting in any manner. Any of the following features may be optionally incorporated with or without the exclusion of other features described.

In one embodiment, the systems and methods described herein may function to implement audio artifact reduction for low bit-rate audio codecs that use high-frequency regeneration. For example, because of their superior bit-rate efficiency, low bit-rate audio codecs that use high-frequency regeneration have been increasingly used for over-the-air TV broadcasting systems. To wireless carriers who desire to offer high-quality TV services over their wireless infrastructure, efficient use of the valuable wireless spectrum is important. Unfortunately, high efficiency generally means very little redundancy in the compressed audio signal. Therefore, when an error occurs due to poor wireless channel conditions associated with interference, the effect of the error in decoded audio output is large and may propagate over time.

Typically, the error conditions may be detected at the receiver by three techniques. The first technique includes checking a forward-error correction checksum [e.g., Cyclic Redundancy Check (CRC)] for every audio frame. If the checksum of the encoded frame bits does not match the checksum sent in the frame, the frame is declared to be in error. The second technique requires that the audio decoder perform a sanity check on parameters during decoding. If a particular parameter does not fall in valid range, the frame may be declared to be in error or the particular parameter may be declared to be unreliable (e.g. and be corrected, etc.).

Finally, with respect to the third technique, since the TV transmission and other similar applications are real-time, the receivers must produce audio output within a time window. If the frame is not received over the air before it is to be presented to the listener, the frame is considered to have arrived late and in error. This scenario is typical for a packet-based network transmission. In general, a late-arriving or lost packet may result in loss of more than one frame.

Once the decoder detects an error by one or more of above techniques, the decoder attempts to perform error concealment to avoid artifacts or gaps in audio presented to the viewer or listener. In conventional decoders, error concealment involves filling in the missing audio samples for a frame. There are various techniques for doing this, such as silence or noise substitution, repetition of a last good frame, waveform substitution (such as pitch waveform, etc.), and time-scale modification, etc.

In 3GPP, the HE-AAC decoder (also referred to as 3GPP enhanced AAC Plus decoder), the core AAC decoder, and the SBR decoder apply concealment separately. The error concealment is specified as additional decoder tools in the 3GPP specification TS 126.402.

The AAC core decoder employs signal-adaptive spectrally shaped noise generation for error concealment. In the high-frequency regeneration part, i.e. the SBR decoder, error concealment is based on extrapolation of the spectral envelope and guidance parameters.

In practice, however, there are a variety of scenarios when the errors are not detected. This happens, for example, when the number of errors is larger than the CRC detection capability, or they happen in bursts that are longer than the error protection capacity. In the case of most audio codecs based on perceptual transform based algorithms, this does not cause severe distortions. This is because the parameters that are coded are individual scale-factors for audio frequency bands and the quantized rescaled transform coefficients. Thus, if there is a wrong scale-factor or transform coefficient index, the decoded audio distortion is localized in a frequency associated with that coefficient or band. In addition, the transform codecs typically use overlapping blocks. Thus, at the decoder, the distortion is also localized and smoothed in time.

Unfortunately, in the case of codecs that utilize the high-frequency generation techniques, an error in the side information data for high-frequency generation can cause severe artifacts. The reason is that frequency spectral envelope data for high-frequency generation is coded using differential coding techniques in either frequency, time, or in both frequency and time. Thus, the error typically propagates and is not localized. Further, many times the high-frequency regeneration data is sent as extension data in the bit-stream and may not be protected by CRC or other forward-error correction, exacerbating the problem. In theory, the parameter sanity or plausibility tests of the erroneous parameters should detect some of these errors. However, there are still errors that can get through in practice.

Typical loud and annoying artifacts are caused in HFR codecs when the audio signal in the regenerated high-frequency band represents a large jump both with respect to a previous frame associated with the lower band and that is not in line with change in the regenerated low-frequency band from frame to frame.

Accordingly, in one embodiment, such a drastic and unexpected change in spectral energy of the HFR audio signal may be detected and prevented by altering the spectral energy to be in line with the change in lower frequencies that are decoded by a core decoder.

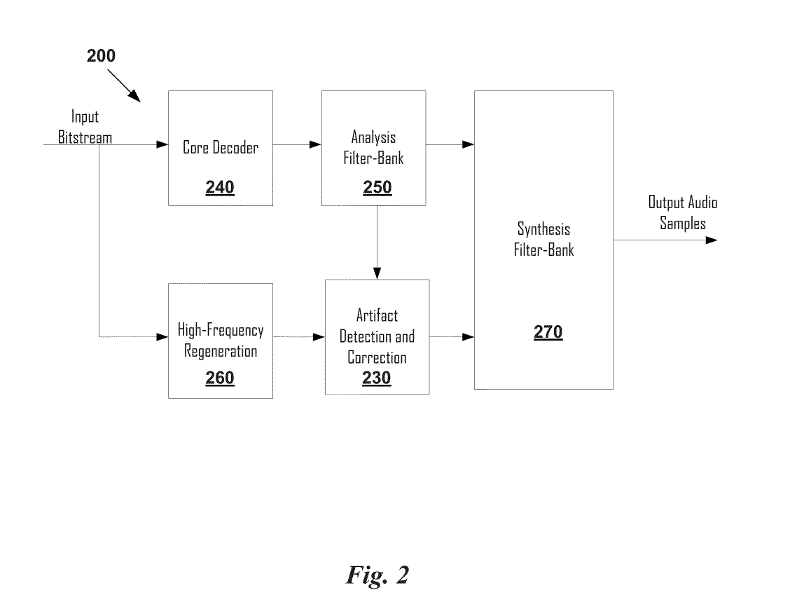

FIG. 2 illustrates a decoder system 200 for artifact reduction in high-frequency regeneration audio signals, in accordance with one embodiment. As an option, the decoder system 200 may be implemented in the context of the previous Figures and/or any subsequent Figure(s). Of course, however, the decoder system 200 may be implemented in any desired environment. It should also be noted that the aforementioned definitions may apply during the present description.

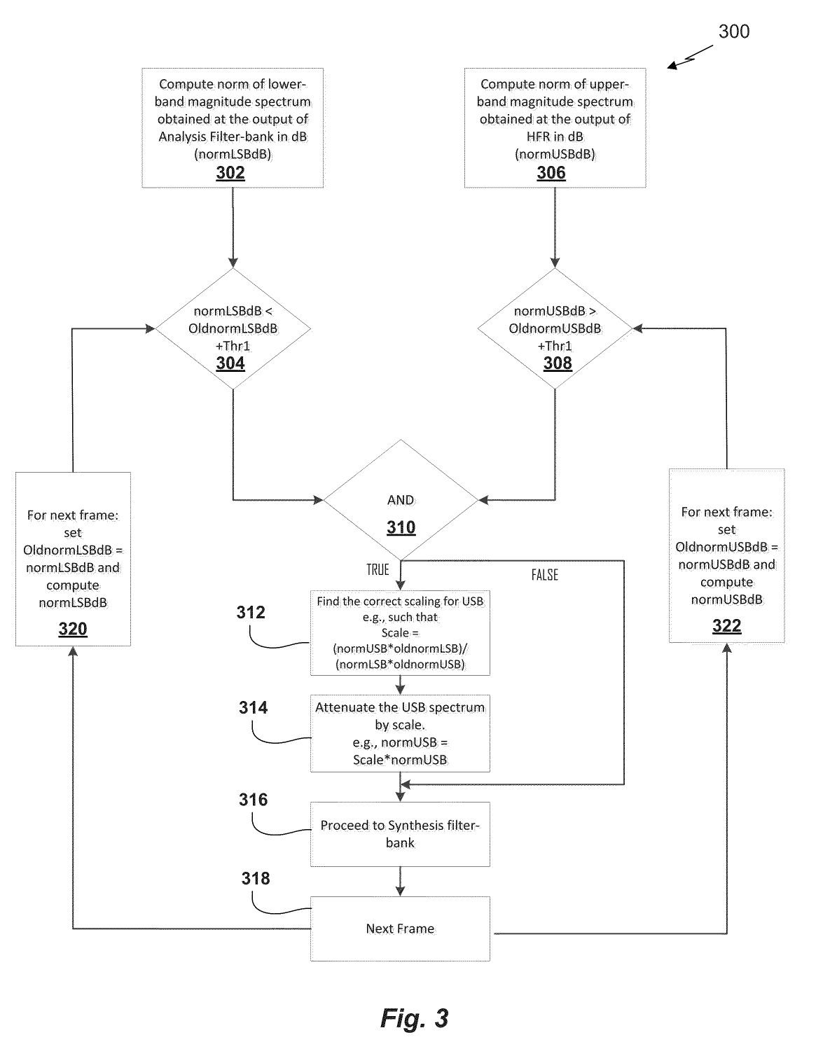

As shown, the decoder system 200 includes an artifact detection and correction processing module 230 for removing artifacts due to erroneous side information while decoding the HFR spectrum. In operation, such decoder system 200 may function to detect and prevent drastic and unexpected changes in the spectral energy of the HFR audio signal by altering the spectral energy to be in line with the change in lower frequencies that are decoded by a core decoder 240. In one embodiment, the decoder system 200 may implement functionality associated with a method as shown in FIG. 3.

FIG. 3 illustrates a flowchart of a method 300 for artifact reduction in high-frequency regeneration audio signals, in accordance with another embodiment. As an option, the method 300 may be implemented in the context of the previous Figures and/or any subsequent Figure(s). Of course, however, the method 300 may be implemented in any desired environment. It should also be noted that the aforementioned definitions may apply during the present description.

As shown, a defined normal (i.e. the norm, normLSBdB) of a current frame's lower-band magnitude spectrum obtained at the output of an analysis filter-bank is computed (e.g. the analysis filter-bank 250 of FIG. 2, etc.). See operation 302. Additionally, the artifact detection and correction processing module 230 determines whether the current lower-band magnitude spectrum norm (normLSBdB) is less than the sum of a previous frame's lower-band magnitude spectrum norm (OldnormLSBdB) and a predetermined threshold (Thr1). See decision 304.

Further, a defined norm (i.e. the norm, normUSBdB) of a current frame's upper-band magnitude spectrum obtained at the output of an HFR module (e.g. the HFR module 260 of FIG. 2, etc.) is computed by the artifact detection and correction processing module 230. See operation 306. Further, the artifact detection and correction processing module 230 determines whether the current upper-band magnitude spectrum norm (normUSBdB) is greater than the sum of a previous frame's upper-band magnitude spectrum norm (OldnormUSBdB) and a predetermined threshold (Thr1). See decision 308.

If the current upper-band magnitude spectrum norm (normUSBdB) is greater than the sum of a previous frame's upper-band magnitude spectrum norm (OldnormUSBdB) and a predetermined threshold (Thr1) and the current frame's lower-band magnitude spectrum norm (normLSBdB) is less than the sum of a previous frame's lower-band magnitude spectrum norm (OldnormLSBdB) and a predetermined threshold (Thr1), the artifact detection and correction processing module 230 determines a correct scaling for the upper-band magnitude spectrum. See decision 310 and operation 312. In one embodiment, different threshold values are used for the upper-band and the lower-band. In one embodiment, such scaling may equal the product of the current frame's upper-band magnitude spectrum norm (normUSB) and the previous frame's lower-band magnitude spectrum norm (OldnormLSB) divided by the product of the current frame's lower-band magnitude spectrum norm (normLSB) and the previous frame's upper-band magnitude spectrum norm (OldnormUSB). For a magnitude spectrum norm, normUSB=10^{normUSBdB/20}, OldnormUSB=10^{OldnormUSBdB/20}, and so forth.

Once the scaling is determined, the artifact detection and correction processing module 230 attenuates the upper-band magnitude spectrum by the determined scale and generates a scaled result. See operation 314. Furthermore, the scaled result is input into a synthesis filter-bank (e.g. the synthesis filter-bank 270 of FIG. 2, etc.). See operation 316. The algorithm then proceeds to process the next frame of data. See operation 318. The artifact detection and correction processing module 230 then sets the OldnormLSBdB equal to the current normLSBdB and sets the OldnormUSBdB to the current normUSBdB, and computes a new normLSBdB and new normUSBdB to process the next frame. See operations 320 and 322.

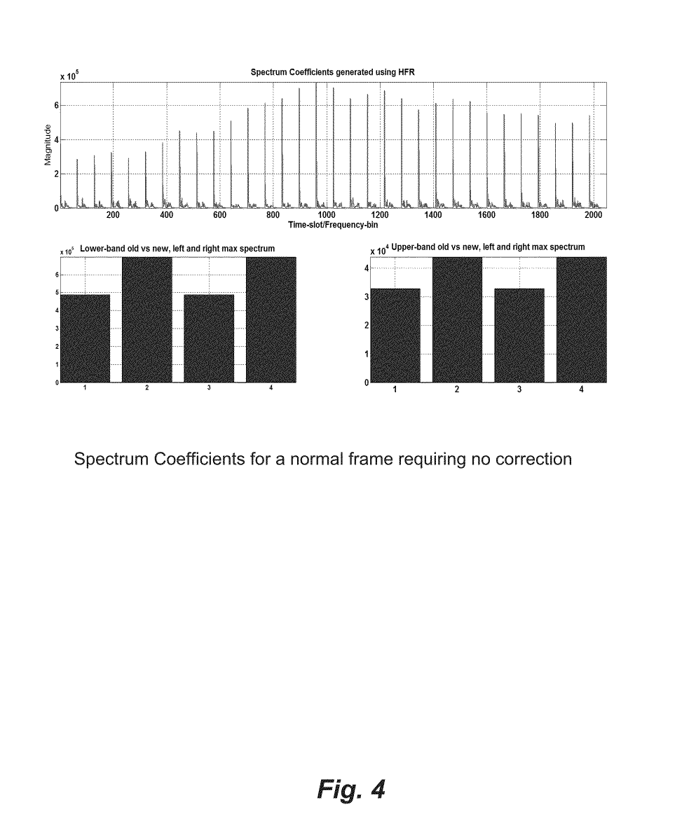

As an example of one implementation, a typical enhanced AAC+ frame is shown in FIG. 4. In this frame, both the upper-band regenerated spectrum and lower-band spectrum change in a similar fashion and proportion. The norm used in this case is the absolute maximum magnitude across time-slots and frequency bins for the frame. The norm increased by approximately 20% in the current frame (columns 2 and 4 represent the left and right channels for the current frame, respectively) compared to the previous frame (columns 1 and 3 represent the left and right channels for the previous frame, respectively) in both lower and upper-frequency bands. The algorithm will consider that there is no HFR artifact in this frame and will apply no scaling correction. Specifically, at step 310, the artifact detection and correction processing module 230 will proceed to step 316 and no scaling correction will be applied.

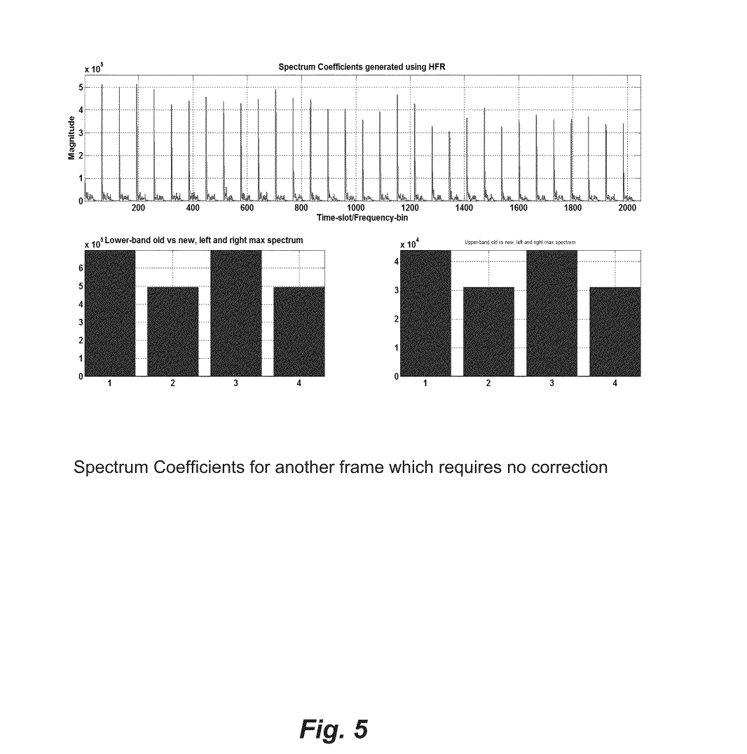

FIG. 5 shows a data frame following the data frame from the example shown in FIG. 4, where the computed norm values (e.g., normLSBdB and normUSBdB) each decrease by approximately by 20% compared with the old norm values (e.g., OldnormLSBdB and OldnormUSBdB) in both the lower and upper-frequency regions. Again, no artifact is detected and no correction is applied by the algorithm.

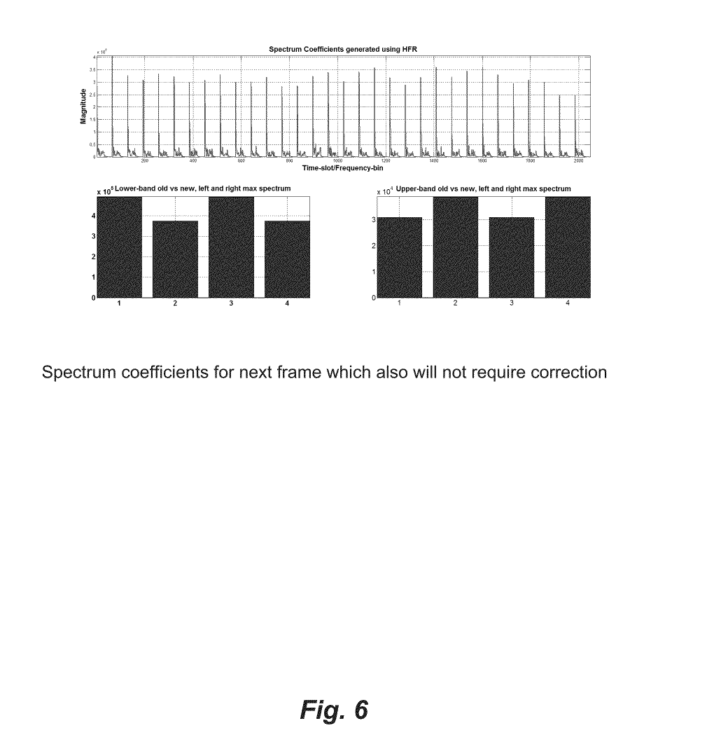

For the next frame, shown in FIG. 6, the situation is different. The lower-frequency norm (normLSBdB) decreased by approximately 20% while the upper-frequency band norm (normUSBdB) increased by approximately 25%. Although the upper-band has not followed the change in computed norm value in-line with the lower-band, the change may still be within an acceptable and plausible audio spectrum evolution trajectory. Therefore, whether or not the algorithm applies a scaling correction is determined based on the threshold (Thr1). In one embodiment, the threshold may be set to a value so that a scaling correction is not applied for the example shown in FIG. 6.

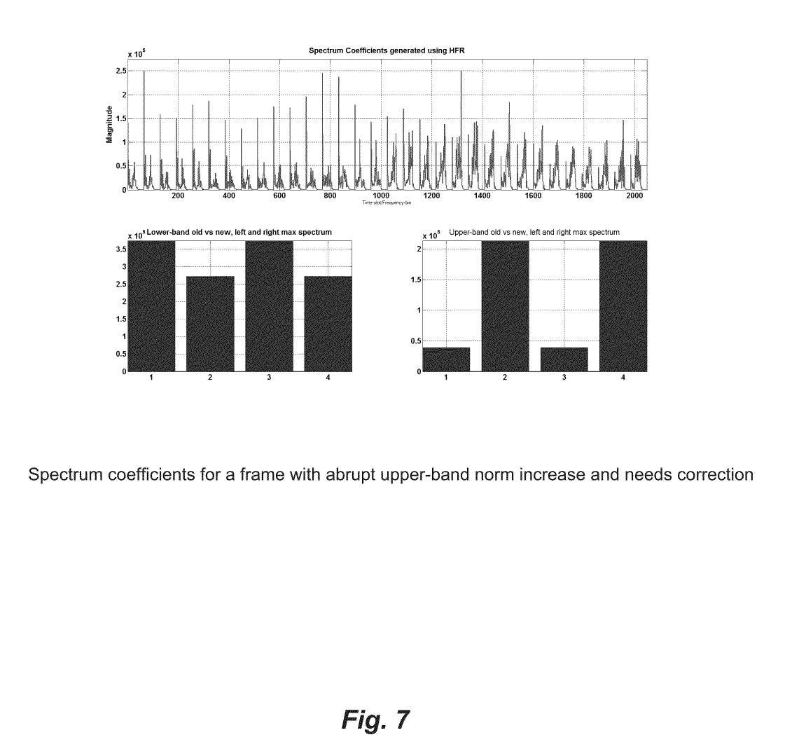

Finally, the next frame shown in FIG. 7 illustrates a frame with an upper-band abrupt increase artifact. In this frame, while the lower-band norm (normLSBdB) decreased by approximately 20%, the upper-band norm (normUSBdB) increased almost five-fold. Clearly, this is an abrupt increase in the upper-band and is not associated with similar change in lower-band norm. Thus, the algorithm applies scaling correction in this frame and reduces the energy of the upper-band spectrum coefficients. The synthesis filter-bank 270 then performs frequency-to-time conversion and the reconstructed audio (output audio samples) does not have any unpleasant artifacts (e.g. such as loud squeaks, etc.).

In various embodiments, definition of the correct threshold, and definition of the norm (e.g. max, square-max, average, etc.) should be considered, based on the desired implementation. By judiciously choosing these, the practitioner of the algorithm can strike an appropriate trade-off between affecting audio quality vs. reducing artifacts, depending on end-user application and the communication channel conditions. In one embodiment, the threshold may be determined based on experimental data. In one embodiment, the threshold by dynamically adjusted based on the correction history or some other input.

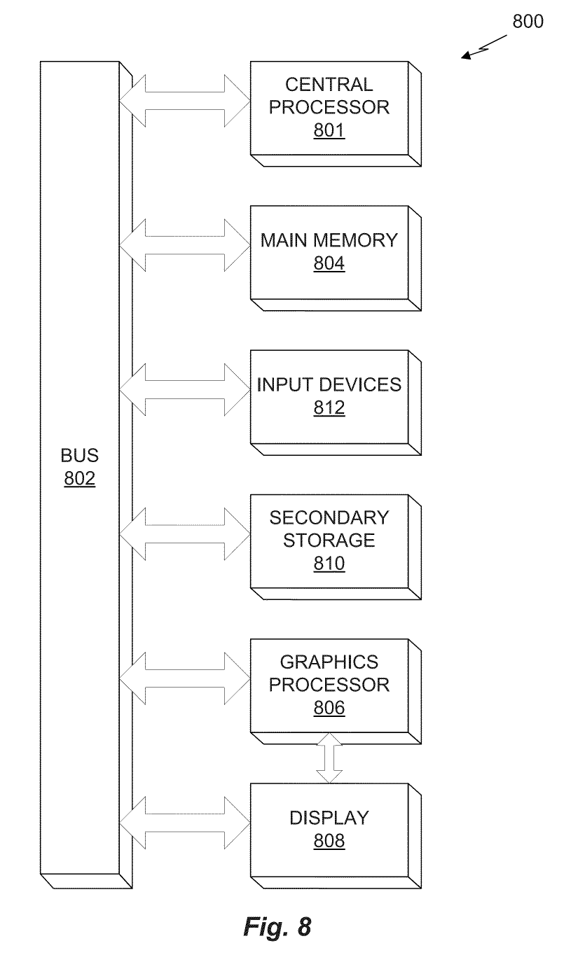

FIG. 8 illustrates an exemplary system 800 in which the various architecture and/or functionality of the various previous embodiments may be implemented. As shown, a system 800 is provided including at least one central processor 801 that is connected to a communication bus 802. The communication bus 802 may be implemented using any suitable protocol, such as PCI (Peripheral Component Interconnect), PCI-Express, AGP (Accelerated Graphics Port), HyperTransport, or any other bus or point-to-point communication protocol(s). The system 800 also includes a main memory 804. Control logic (software) and data are stored in the main memory 804 which may take the form of random access memory (RAM).

The system 800 also includes input devices 812, a graphics processor 806, and a display 808, i.e. a conventional CRT (cathode ray tube), LCD (liquid crystal display), LED (light emitting diode), plasma display or the like. User input may be received from the input devices 812, e.g., keyboard, mouse, touchpad, microphone, and the like. In one embodiment, the graphics processor 806 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 800 may also include a secondary storage 810. The secondary storage 810 includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner.

Computer programs, or computer control logic algorithms, may be stored in the main memory 804 and/or the secondary storage 810. Such computer programs, when executed, enable the system 800 to perform various functions. For example, a compiler program that is configured to examiner a shader program and enable or disable attribute buffer combining may be stored in the main memory 804. The compiler program may be executed by the central processor 801 or the graphics processor 806. The main memory 804, the storage 810, and/or any other storage are possible examples of computer-readable media.

In one embodiment, the architecture and/or functionality of the various previous figures may be implemented in the context of the central processor 801, the graphics processor 806, an integrated circuit (not shown) that is capable of at least a portion of the capabilities of both the central processor 801 and the graphics processor 806, a chipset (i.e., a group of integrated circuits designed to work and sold as a unit for performing related functions, etc.), and/or any other integrated circuit for that matter.

Still yet, the architecture and/or functionality of the various previous figures may be implemented in the context of a general computer system, a circuit board system, a game console system dedicated for entertainment purposes, an application-specific system, and/or any other desired system. For example, the system 800 may take the form of a desktop computer, laptop computer, server, workstation, game consoles, embedded system, and/or any other type of logic. Still yet, the system 800 may take the form of various other devices including, but not limited to a personal digital assistant (PDA) device, a mobile phone device, a television, etc.

Further, while not shown, the system 800 may be coupled to a network (e.g., a telecommunications network, local area network (LAN), wireless network, wide area network (WAN) such as the Internet, peer-to-peer network, cable network, or the like) for communication purposes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method, comprising:
receiving a high-frequency regeneration (HFR) audio signal:
detecting one or more artifacts in the received HFR audio signal, utilizing a spectral energy associated with the received HFR audio signal; and
modifying the received HFR audio signal to at least partially correct the one or more artifacts in the received HFR audio signal.

2. The method of claim 1, wherein detecting the one or more artifacts in the received HFR audio signal includes detecting a change in the spectral energy of the received HFR audio signal.

3. The method of claim 2, further comprising comparing the detected change in the spectral energy of the HFR audio signal to a threshold to detect the one or more artifacts in the received HFR audio signal.

4. The method of claim 1, wherein detecting the one or more artifacts in the received HFR audio signal includes detecting artifacts caused by an HFR codec.

5. The method of claim 4, wherein detecting the one or more artifacts in the received HFR audio signal includes detecting an increase in spectral energy of a regenerated high-frequency band associated with the received HFR audio signal with respect to spectral energy of a lower-frequency band associated with the received HFR audio signal band, and a change in a frame to frame spectral energy associated with the HFR audio signal.

6. The method of claim 1, wherein detecting the one or more artifacts in the received HFR audio signal includes detecting a change in spectral energy of a high-frequency band associated with HFR audio signal.

7. The method of claim 6, further comprising comparing the change in the spectral energy of the HFR audio signal for a current frame and a previous frame and a threshold.

8. The method of claim 1, further comprising separately comparing spectral energy of a high-frequency band associated with the HFR audio signal for a current frame and spectral energy of a high-frequency band associated with the HFR audio signal for a previous frame, and a spectral energy of a low-frequency band associated with the HFR audio signal for the current frame and spectral energy of a low-frequency band associated with the HFR audio signal for the previous frame.

9. The method of claim 8, further comprising determining whether to modify the spectral energy of the high-frequency band, based on the comparison.

10. The method of claim 8, further comprising modifying the spectral energy of the high-frequency band based on the comparison.

11. The method of claim 1, wherein modifying the received HFR audio signal to correct the one or more artifacts in the received HFR audio signal includes altering a spectral energy associated with the HFR audio signal to correspond to a change in lower frequencies that are decoded by a core decoder.

12. The method of claim 1, further comprising computing a defined normal of a lower-band magnitude spectrum obtained at an output of an analysis filter-bank.

13. The method of claim 12, further comprising determining a scaling factor for the upper-band magnitude spectrum, based on the defined normal of a lower-band magnitude spectrum.

14. The method of claim 13, further comprising attenuating the upper-band magnitude spectrum, based on the determined scaling factor.

15. The method of claim 14, further comprising performing frequency-to-time conversion on a signal associated with the attenuated upper-band magnitude spectrum, wherein the modified received HFR audio signal includes a result of performing the frequency-to-time conversion on the signal associated with the attenuated upper-band magnitude spectrum.

16. The method of claim 12, wherein the norm of the lower-band magnitude is determined utilizing at least one of an operation for determining a maximum, an operation for determining the square root of the maximum, or an operation for determining an average.

17. The method of claim 1, further comprising computing a defined normal of an upper-band magnitude spectrum obtained at an output of an HFR module.

18. The method of claim 1, further comprising attenuating an upper-band magnitude spectrum to reduce an energy associated with upper-band spectrum coefficients.

19. A non-transitory computer-readable storage medium storing instructions that, when executed by a processor, cause the processor to perform steps comprising:
receiving a high-frequency regeneration (HFR) audio signal;
detecting one or more artifacts in the received HFR audio signal, utilizing a spectral energy associated with the received HFR audio signal; and
modifying the received HFR audio signal to at least partially correct the one or more artifacts in the received HFR audio signal.

20. A system comprising:
a memory system; and
a processor coupled to the memory system and configured to:
receive a high-frequency regeneration (HFR) audio signal;
detect one or more artifacts in the received HFR audio signal, utilizing a spectral energy associated with the received HFR audio signal; and
modify the received HFR audio signal to at least partially correct the one or more artifacts in the received HFR audio signal.
